(19) United States
(12) Patent Application Publication
(10) Pub. No.: US 2005/0276572 A1
(43) Pub. Date: Dec. 15, 2005

(54) Providing audio-visual content

(75) Inventors: Jeremy Mayo Boswell, Llantwit Major (GB); Jonathan Mark Kendrick, Claverly (GB); Timothy John Revell, Wolverhampton (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Rok Productions Limited, Wolverhampton (GB)

(21) Appl. No.: 11/151,701

(22) Filed: Jun. 13, 2005

Related U.S. Application Data
(60) Provisional application No. 60/617,877, filed on Oct. 12, 2004.

(30) Foreign Application Priority Data
Jun. 14, 2004 (GB) 0413231.2

(51) Int. Cl. H04N 5/76; H04N 5/781

(52) U.S. Cl. 386/46; 386/125

(57) ABSTRACT

An automated extraction configuration module 16 examines metadata stored on a DVD 15 to determine the configuration of content data stored on it. Extraction configuration data from a memory area 17 is utilised by a DVD decryption and extraction module 18 to extract movie data from the DVD 15, which is written as AVI data to an intermediate format movie data area 14. A mobile format conversion module 19 converts movie data stored in the extracted movie data area 14 and provides a movie in mobile telephone consumable format in a mobile format movie data area 20. The mobile format conversion module 19 utilises a digital rights management (DRM) processing module 21. The conversion uses information specific to the configuration of, and thus is tailored to, a target device. The data also includes two or more media players and a loader program. The mobile device is controlled to run the loader program initially. The program detects the relevant configuration of the mobile device and determines which of the media players to use to consume the movie content data.

### DESCRIPTION

The invention relates to apparatus for providing audio-visual content for reproduction on a mobile device, and to a method of providing audio-visual content for reproduction on a mobile device. The invention relates also to data stored on a portable medium or existing at least transiently in memory, and to a method of operating a mobile device.

There is a trend for mobile telephones, also known as cellular telephones, to be provided with colour displays having many thousands of pixels. As time progresses the quality of these displays and the resolutions afforded thereby increases. Furthermore, semiconductor terminology is such the mobile telephones can be provided with quite substantial amounts of memory. Whereas previously it has been known to incorporate MP3 players and the like into mobile telephones, the provision of improved displays and increased amounts of memory allows mobile telephones to be used for use as limited digital television receivers. It has been proposed as well to provide audio-visual content on a multimedia card (MMC), for viewing on a mobile telephone. The Nokia™ 7610 is one such capable mobile telephone. This telephone can handle 3GPP and RealMedia audio-visual formats.

Providing audio-visual content for consumption on a mobile device currently is a laborious and time-consuming process. It is an aim of the present invention to provide apparatus and a method for providing audio-visual content for reproduction on a mobile device which is convenient yet capable of utilising the full capabilities of a target mobile device.

According to a first aspect of the invention, there is provided apparatus for providing audio-visual content for reproduction on a mobile device, the apparatus comprising:

an audio-visual content supply arrangement;

the apparatus being arranged to write into an area of memory data constituting:
audio-visual content;
two or more different media players; and
a loader program,
   the loader program being arranged such that when loaded into a mobile device it causes configuration parameters of the mobile device to be determined, causes one of the media players to be selected on the basis of the detected configuration parameters, and controls the mobile device to use the selected media player.

In this way, it is possible to utilise for example an MMC card for a greater number of target device configurations. This can be advantageous, especially when for instance MMC cards are intended for retail from a shop display or similar.

The loader program may be arranged to control the mobile device to detect whether or not it already includes a suitable media player and, if a suitable media player is detected, this is controlled to be used instead of installing a media player from the area of memory onto the mobile device.

This can be advantageous since it can reduce the possibility of there being an installation or deinstallation error, thereby improving the reliability of the mobile device.

The two or more media players may be provided through a single configurable media player software application. In this case, the loader program is operable to determine what media player is required, and to operate appropriate software modules forming part of the media player software. Thus, multiple media players can be made up from a single software application, which reuses modules or functions for certain media player functionality.

If the two or more media players are provided through a single configurable media player software application, the loader program may form part of the media player software application.

According to a second aspect of the invention, there is provided data stored on a portable medium or existing at least transiently in memory, the data constituting:
audio-visual content;
two or more different media players; and
a loader program,
   the loader program being arranged such that when loaded into a mobile device it causes configuration parameters of the mobile device to be determined, causes one of the media players to be selected on the basis of the detected configuration parameters, and controls the mobile device to use the selected media player.

According to a third aspect of the invention, there is provided a method of providing audio-visual content for reproduction on a mobile device, the method comprising:
writing into an area of memory data constituting:
   audio-visual content;
   two or more different media players; and
   a loader program,
      the loader program being arranged to cause a mobile device to determine configuration parameters of the mobile device, to select one of the media players on the basis of the detected configuration parameters, and to control the mobile device to use the selected media player.

According to a fourth aspect of the invention, there is provided a method of operating a mobile device, the method comprising:

storing audio-visual content data and two or more different media players in internal and/or external memory;

determining configuration parameters of the mobile device,

selecting one of the media players on the basis of the detected configuration parameters, and

using the selected media player to consume the audio-visual content data.

The term “mobile device” will be understood to embrace mobile (cellular) telephones and personal digital assistants having bidirectional voice communication capabilities, as well as other mobile devices, including dedicate media players and the like.

Embodiments of the present invention will now be described by way of example only, with reference to the accompanying drawings in which:

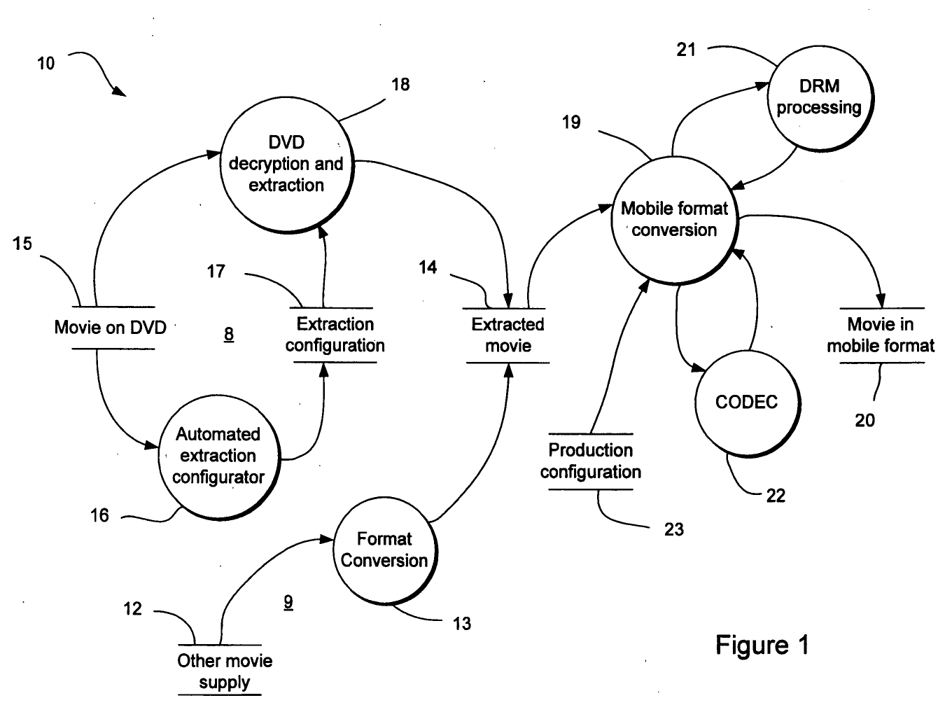

FIG. 1 is a schematic diagram of audio-visual content provision apparatus embodying the invention;

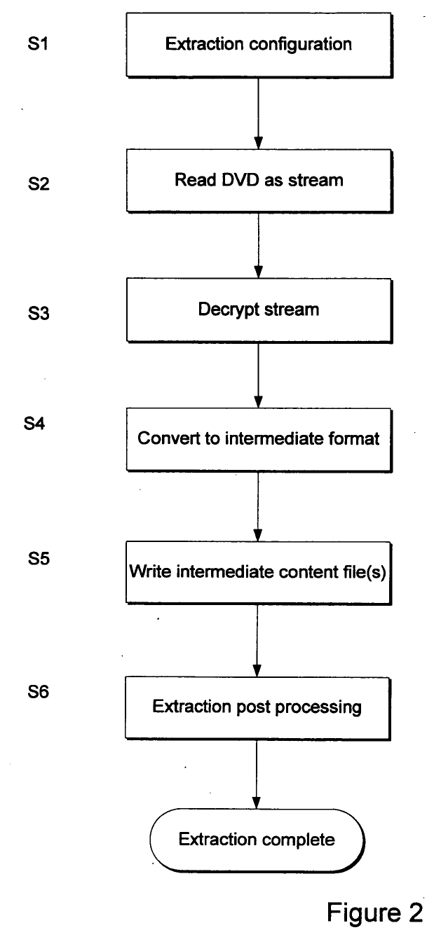

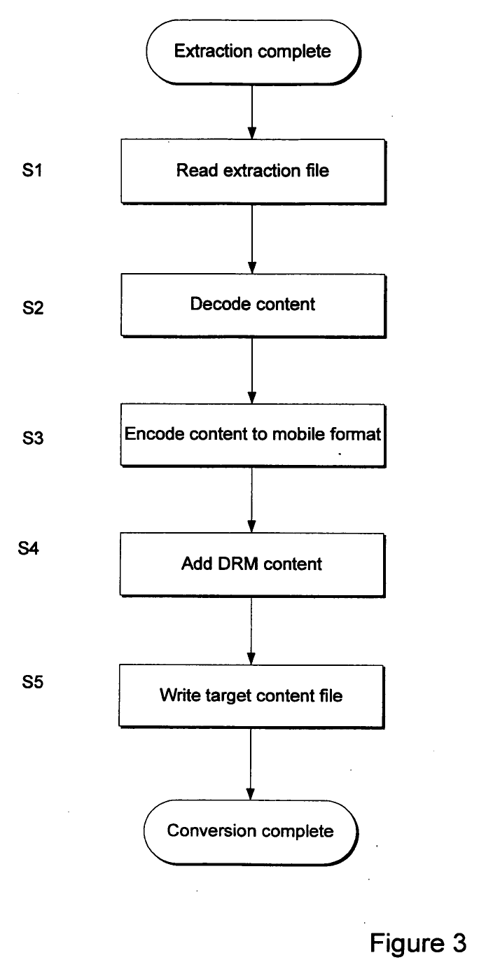

FIGS. 2 and 3 are flowcharts illustrating steps of operation of the FIG. 1 apparatus;

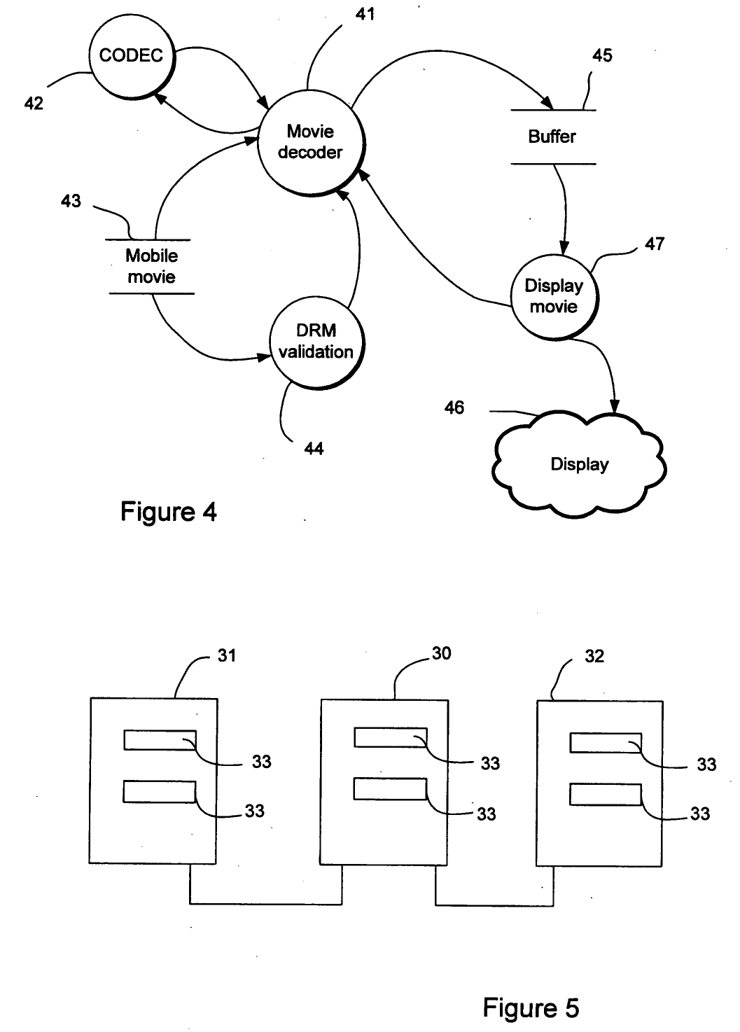

FIG. 4 is a schematic drawing illustrating apparatus for playback of the converted audio-visual content in a mobile telephone; and

FIG. 5 is a schematic drawing of a system of interconnected computers operable according to the invention.

Referring firstly to FIG. 1, content extracting and converting apparatus 10 is illustrated schematically. Two alternative sources of audio-visual content 8, 9 are included. A first content source 8 utilises film or movie data stored on a DVD (digital video disk or digital versatile disk) 15. An automated extraction configuration module 16 examines metadata stored on the DVD 15 to determine the configuration of content data stored on the DVD. This involves the application of a tcprobe, and an analysis of the information returned from the DVD 15. This is described in more detail below. The result is data stored in an extraction configuration memory area 17 representing an extraction configuration. The extraction configuration data from the memory area 17 is utilised by a DVD decryption and extraction module 18 to extract movie data (i.e. the content data) from the DVD 15. The result is content data in an intermediate format, which is written to an intermediate format movie data area 14. The data included in the intermediate format movie data area 14 is in predetermined format and is suitable for conversion into a form ready for reproduction on a mobile telephone (not shown). Preferably the intermediate format is AVI. This format has the advantage of high resolution, yet is relatively easy to handle and it is relatively easy to convert from AVI into 3GPP and many other formats suitable for use by mobile devices.

The second source of audio-visual content 9 receives from a movie data storage area 12 data representing a movie (or film) in AVI (audio-visual interleave) or other format. The movie so supplied is converted by a format conversion module 13 before being written to the intermediate format movie data area 14.

Thus, either of the audio-visual content sources 8, 9 can be used to provide movie data in the intermediate format movie data area 14.

A mobile format conversion module 19 converts movie data stored in the extracted movie data area 14 and provides a movie in mobile telephone consumable format in a mobile format movie data area 20. The mobile format conversion module 19 utilises a digital rights management (DRM) processing module 21, which allows certain control over the access and distribution of the resulting movie data. The conversion effected by the mobile format conversion module 19 uses a codec 22, which preferably is custom-designed for the purpose. Importantly, the conversion effected by the mobile format conversion module 19 uses information stored in a production configuration data area 23. By controlling the mobile format conversion module 19 on the basis of information specific to the configuration of, and thus tailored to, a target device, the apparatus 10 can be used to provide movie data for any of potentially a large number of target mobile devices.

The extraction effected by the audio-visual content source 12 will now be described in detail with reference to FIG. 2.

In FIG. 2, extraction configuration is effected at step S1. This utilises the automated extraction configuration 16 shown in FIG. 1. Extraction configuration commences by analysing the DVD source 15. The result of an example analysis, i.e. what is returned in response to a query, is illustrated below:
(dvd_reader.c) mpeg2 pal 16:9 only letterboxed UO 720×576 video
(dvd_reader.c) ac3 en drc 48 kHz 6 Ch
(dvd_reader.c) ac3 de drc 48 kHz 6 Ch
(dvd_reader.c) ac3 en drc 48 kHz 2 Ch
(dvd_reader.c) subtitle 00=<en>
(dvd_reader.c) subtitle 01=<de>
(dvd_reader.c) subtitle 02=<sv>
(dvd_reader.c) subtitle 03=<no>
(dvd_reader.c) subtitle 04=<da>
(dvd_reader.c) subtitle 05=<fi>
(dvd_reader.c) subtitle 06=<is>
(dvd_reader.c) subtitle 07=<en>
(dvd_reader.c) subtitle 08=<de>
[tcprobe] summary for /media/dvdrecorder/, (*)=not default, 0=not detected
   import frame size: −g 720×576 [720×576]
   aspect ratio: 16:9 (*)
   frame rate: −f 25.000 [25.000] frc=3
   audio track: −a 0 [0] −e 48000,16,2 [48000,16,2] −n 0×2000 [0×2000]
   audio track: −a 1 [0] −e 48000,16,2 [48000,16,2] −n 0×2000 [0×2000]
   audio track: −a 2 [0] −e 48000,16,2 [48000,16,2] −n 0×2000 [0×2000]
[tcprobe] V: 185950 frames, 7438 sec @ 25.000 fps
[tcprobe] A: 116.22 MB @ 128 kbps
[tcprobe] CD: 650 MB|V: 533.8 MB @ 602.0 kbps
[tcprobe] CD: 700 MB|V: 583.8 MB @ 658.4 kbps
[tcprobe] CD: 1300 MB|V: 1183.8 MB @ 1335.1 kbps
[tcprobe] CD: 1400 MB|V: 1283.8 MB @ 1447.9 kbps

This information is returned by tcprobe, which is part of transcode. Part of the extraction configuration process of S1 involves determining the configuration of the target device, which is represented by the information stored in the production configuration data area 23. It is helpful therefore to understand the information that is stored there.

Information data stored in the production configuration data area 23 identifies the aspect ratio of the display of the target device. In most cases, the aspect ratio 4:3, although this may vary form device to device. Certain devices will include 16:9 (widescreen) aspect ratios, although in practice the aspect ratio may take a value which is not the same as a conventional television aspect ratio. The production configuration data also identifies the audio language required. It also identifies whether or not subtitles are required. If they are required, the production information configuration identifies the language that the subtitles are required to be in. The bitrates of the video and the audio tracks are included in the production configuration data. The bitrates may depend on the capabilities of the target device, on the particular media player installed in the target device or on any other factors. The production configuration data may also indicate a maximum volume size, for example indicating the amount of usable memory in an MMC. The production configuration information also includes an indication of the format on which the movie data is to be stored. For example, this format can be 3GPP or MPEG-4 format, or any other suitable format.

The information included in the production configuration data area 23 also includes the type of the target device. This may be, for example, a model number of the mobile telephone on which the movie is to be reproduced. In some circumstances, it may be possible that two different mobile telephones having the same model number can have different hardware and/or software configurations. Where different configurations are possible, and this may have a bearing on the optimum processing effected by the apparatus 10, the information stored in the production configuration data area 23 preferably also includes details of how the hardware and/or software configuration departs from the standard configuration, or perhaps instead merely specifies the configuration.

The automated extraction configuration module 16 determines from the information returned by tcprobe, (in particular the first line thereof reproduced above) that the DVD 15 contains only widescreen (that is 16:9 aspect ratio) video in MPEG 2 PAL format. The module 16 also determines that there are three audio tracks, identified by the second and fourth lines respectively. The first and second tracks have 6 channels each and 48 kHz sampling rates. The first is in the English language and the second is in the German language, as identified by the “en” and “de” designations. The third audio track is in the English language and is a stereo (two channel) signal having a 48 kHz sampling rate. The module determines also that the DVD 15 has eight subtitle tracks, in various languages. The module 16 also determines the frame rate, the number of frames and the length of the movie. The module 16 uses the last four lines of the returned information to determine the content bitrate variations that can be extracted from the DVD 16.

The function of the automated extraction configuration module 16 also includes obtaining decryption keys, which are needed to allow the audio-visual content on the DVD to be reproduced.

The information determined by the automated extraction configuration module 16 constitutes the configuration of the DVD 15.

Based on the information in the production configuration data area 23 and on the DVD configuration information, the automated extraction configuration module 16 makes a decision as to which audio tracks, which video channel (if there is more than one video channel) and which subtitle track are needed. Typically, the subtitle track identified by this process is the first listed subtitle track which is in the same language as the subtitle language identified in the production configuration data area 23. Also, the audio track identified by this process is the audio track which is in the same language as the audio language identified in the production configuration data area 23 and which is most suitable for use by the target device. In most cases, and Dolby™ Pro Logic™ audio channels will not be suitable, because most target devices will not be equipped to handle such audio signals. A stereo audio track will in most cases be the most suitable audio track, although any mono track may be most suitable for a target device with only mono audio capabilities. The video channel selected by this process typically is the main channel, i.e. the actual movie, and not any ‘additional features’, such as trailers and behind-the-scene documentaries and the like that are commonly included on DVDs. Data identifying the tracks and channels identified by this process is stored in the extraction configuration data area 17.

In step S2, the data stored on the DVD 15 is read as a stream. This is represented by the arrow between the movie on DVD data area 15 and the DVD decryption and extraction module 18.in FIG. 1. It is only the content which is read at this time, since the configuration information, or metadata, is not used by the DVD decryption and extraction module 18 directly. Also, it is only the relevant content which is read. The relevant content is identified to the DVD decryption and extraction module 18 by the information stored in the extraction configuration data area 17, which identifies the relevant video channel, the relevant audio channel and any relevant subtitle channel. At step S3, the relevant portions of the DVD data stream are decrypted by the DVD decryption and extraction module 18. This decryption uses transcode with the keys extracted by the automated extraction configuration module 16. Decryption is performed “on the fly”, i.e. as a continuous process as the content is read from the DVD 15. As the data is decrypted, it is converted into the intermediate format, i.e. AVI format. At step S5, the movie data is written into the extracted movie data buffer 14 as a file or series of files in the intermediate format.

At step S6, extraction post-processing is performed. This involves splitting or joining the content file or files present in the extracted movie data buffer 14 into components. Whether there is any splitting or any joining and the extent of it depends on the target device configuration information stored in the production configuration data area 23. In most cases, this step will involve splitting the extracted content cleanly to multiple volumes. Providing movie content in the form of multiple volumes is desirable in many circumstances due to the limitations of mobile telephones. It is a fairly straightforward procedure to split DVD movie content into volumes corresponding to the DVD chapters present on the original DVD 15. Following step S6, the extraction of the movie data is complete.

The result is movie data stored in the extracted movie data buffer 14 which is encoded into an intermediate format (e.g. AVI format) and which includes only one audio track, which is in the required language identified by the production configuration information stored in production configuration data area 23, and optionally one subtitled track, in the required language. The extracted movie data typically is divided into a number of volumes, although this may not be necessary depending on the configuration of the target device.

Instead of using a DVD data source 15, the other movie data storage area 12 may be used. In this case, format conversion to the intermediate format, for example AVI, is carried out by the format conversion module 13. If only DVD sources 15 will be used, then the second content source 9 can be omitted. If included, the format conversion module 13 takes a form which is suitable for the particular type of content provided at the other movie data storage area 12. A separate format conversion module 13 may be needed for each type of data that can be stored in the other movie data storage area 12.

The procedure of FIG. 3 begins with the extraction process complete. At step S1, the extraction file is read. This is an “on the fly” procedure and is represented by the arrow linking the extracted movie data buffer 14 with the mobile format conversion module 19. At step S2, the mobile format conversion module 19 decodes the content comprising the movie data. The step uses transcode. At step S3, the decoded content is encoded into the required mobile format, as identified by the production configuration information stored in the production configuration data area 23. The encoding is performed by the codec 22. The encoding is performed in such a way as to result in audio and video content having the most appropriate bitrates. What are the most appropriate bitrates is determined by the mobile format conversion module 19. In particular, the mobile format conversion module 19 uses knowledge of the number of video frames in the video data and the length of the audio track along with the maximum volume size information stored in the production configuration data area 23 to determine the most suitable bitrates. In most cases, the most suitable bitrates for the audio and video will be the bitrates which are the maximum possible bitrates which could be used to fit the entire content within the maximum volume size.

Usually, the bitrates selected for the audio and the video give rise to comparable quality for those components, although there can be some discrepancy if this results in mobile format movie data which would give an improved playback experience if this is possible having regard to the maximum volume size. For example, if audio and video content at a certain quality level would give rise to data exceeding the maximum volume size but that content at a quality level immediately below that would give rise to a significant shortfall of the volume size, the mobile format conversion module 19 may make a decision to use the higher bitrate for the video content and the lower bitrate for the audio content, so as to make the best use of the available volume size.

If examination of the information stored in the production configuration data area 23 reveals that the target device is not optimised for video playback at the same frame rate as that of the DVD source 15, then this is taken into account by the mobile format conversion module 19. In particular, the mobile format conversion module 19 may modify the frame rate of the content data so that it is optimised for the target mobile device. Typically, this will involve a reduction in the frame rate which, because of the limited display size in most mobile telephones, would not be so noticeable as it would if a full size display were used. If the optimal frame rate is not equal to the source frame rate divided by an integer, then the mobile format conversion module 19 may use frame interleaving to effect a smooth result in the generated movie content when played back on a mobile telephone.

Step S3 thus utilises information stored in the production configuration data area 23 to control the mobile format conversion module 19 to encode the data using the codec 22 into the appropriate data format and with appropriate bitrates.

The production configuration data area 23 may be updatable according to the target device which is of interest in a particular format conversion process. In this case, the production configuration data area 23 will store data for only one target device at a time, and this data is changed as required. Alternatively, the production configuration data area 23 stores a set of data for each of plural target devices, and one of the data sets is selected according to the particular target device of interest at a given time. In either case, the apparatus 10 is easily controlled to carry out a format conversion process which is optimised for each of plural target device configurations.

Digital rights management content is added to step S4. This is implemented by the mobile format conversion module 19 using the DRM processing module 21. The procedure implemented by the step S4 depends on the target format identified by the information stored in the production configuration data area 23. What form of DRM content is added may depend in particular on the form of the codec 22. The form of the codec 22 in turn has an effect on the form of the codec in the media player. In particular, when the codec 22 is a custom codec, a custom form of DRM is used. Here, the form of DRM can be selected to provide optimal operation with the custom media player. If an off-the-shelf codec, such as Real Media™, is used as the codec 22, a suitable DRM will be used.

Assuming it is allowed by the media player and the target device, the DRM content may impose content reproduction and distribution restrictions as follows. One option is to limit viewing of the content to the particular target device or user, as for example identified by an IMEI or an IMSI number or any other unique or quasi-unique serial number. In this case, the serial number needs to be included in the production configuration data area 23, so that the mobile format conversion module 19 can operate with the DRM processing module 21 and the production configuration data area 23 to include suitable DRM content in the movie data. Another option is to allow the movie to be viewable up until a particular time and/or date. Thus, the resulting movie will have a “shelf-life” and will not be viewable after the date and/or time specified by the DRM content. A third option is to allow the movie content to be viewable on a predetermined number of occasions (N times). Once the movie has been viewed N times, the media player in the target device will not allow the content to be refused again, thereby rendering it useless. Alternatively, the media player may be arranged to erase the MMC or otherwise delete or corrupt the movie data immediately after the Nth viewing. Alternatively or in addition, the DRM content can prevent the content being copied or forwarded if not authorised. Thus, it can be said that the DRM content prevents or deters the consumption of the content on mobile devices other than the one for which it was intended and/or copying of the content.

Preferably, the DRM content is encrypted and included in the header of the resulting movie data, although the DRM content may be included in the movie data in any suitable way. Clearly, if a standard DRM process is required to be used by the target device, the DRM content included in the movie data by the mobile format conversion module 19 in the DRM processing module 21 will conform to the relevant standard.

At step S5, the target content is written to the mobile format movie data area 20 as a file. The file may be an area of memory in a computer server, for instance, or the content file may be written directly onto an MMC or other portable transferable media. The file written by this step S5 includes content in the appropriate format, and also DRM content either embedded into the movie content or else in a separate file. After step S5, the conversion is complete, the result is stored in the mobile format movie data area 20 data constituting the movie originally on the DVD data area 15 but encoded in a format suitable for use by the target mobile device and having appropriate audio and video content bitrates. Furthermore, the movie includes suitable DRM content, multiple volumes if appropriate to the format of the target device, a single audio sound track, and optionally a single subtitle track.

Where the video content on the DVD 15 has a different aspect ratio to the display of the target device, there preferably is modification of the video signal from the DVD such that it corresponds to the aspect ratio of the target device. This can be carried out by the DVD encryption and extraction module 18. Preferably however, modification of the video signal from the DVD 15 such that it corresponds to the aspect ratio of the target device is carried out by the mobile format conversion module 19. The modification may involve simple cropping from the left and right sides of images if narrower images are required, or cropping from the top and bottom of images if wider images are required. The modification may involve aswell or instead a limited amount of image stretching, either widthwise or heightwise. In this case, it is preferred to have more picture linearity in the central region of the display than at the edges of the display. Thus, compression or stretching is effected to a greater degree at the edges of the images than it is a central portion. The DVD encryption and extraction module 18 or the mobile format conversion module 19, as the case may be, can be pre-programmed to make a decision as to what cropping and/or stretching is required on the basis of a look-up table relating course aspect ratios to target device aspect ratios and the corresponding modification required, or in any other suitable way.

In accordance with the invention, the data written to the mobile format movie data area 20 also includes two or more media players. This is advantageous for a number of reasons. Firstly, it reduces the number of factors which need to be taken into account by the mobile format conversion module 19. The target device configuration information does not need to include information identifying the media player included in the mobile device, since this is not needed when the media player is included with the movie content data. Secondly, it allows movie content data to be consumed even if no suitable media player, or indeed no media player at all, is included in the mobile device.

The media player or players may be embedded, or alternatively included alongside, the movie content data. Embedding the media player into the content data allows easier control of the movie content, and makes it very difficult for the movie content data to be separated by unauthorised persons. Each media player typically consumes less than 1 MB of memory.

In one embodiment, a number of different media players are stored, along with the movie content data and a loader program. The mobile device is controlled to run the loader program initially. The program detects the relevant configuration of the mobile device and determines therefrom which of the media players to use to consume the movie content data. In this way, it is possible to utilise an MMC card for a greater number of target device configurations, which clearly can be advantageous, especially when the MMC cards are intended for retail from a shop display or similar.

The loader program preferably is arranged to control the mobile device to detect whether or not it already includes a suitable media player. If a suitable media player is detected, this is controlled to be used instead of installing a media player from the MMC card onto the mobile device. This is advantageous since it reduces the possibility of there being an installation or deinstallation error, thereby improving the reliability of the mobile device.

In a second embodiment, instead of including multiple separable media players, multiple media players may be provided through a single configurable media player software application. In this case, the loader program may determine what media player is required, and operate appropriate software modules forming part of the media player software. Software module or functions which are not appropriate for the mobile device configuration are not used. Thus, multiple media players are made up from a single software application, which reuses modules or functions for certain media player functionality. Where a single media player software application is used, the loader program may form part of the media player software application itself.

The movie content data, as well as any media player(s), stored in the mobile format movie data area 20 can be communicated to the target mobile device in any suitable way. For the next few years at least, it is envisaged that mostly MMC or other transferable media will be used to store and transport the movie content. However, as mobile data transfer becomes faster and cheaper, it is expected that movie content will be transferable over-the-air, for example using WAP or 3G data transfer. Transfer may instead be effected by transfer from an Internet connected PC which has downloaded the movie content from a website, using a short range link such as a cable, or wirelessly using IrDA or Bluetooth, or using a transferable storage medium such as an MMC.

A mobile device is shown schematically in FIG. 4. Here, the mobile telephone 40 includes all the conventional components needed for voice communication, although these are not shown for the sake of clarity. The telephone 40 includes a movie decode module 41, which is in bidirectional communication with a codec 42. A movie is stored in a mobile movie data area 43, which may take any suitable form. It may for example be an MMC, a memory space connected by way of an external drive, internal RAM or other memory, or it may take any other suitable form. A DRM validation module 44 is connected to receive DRM data from the data in the mobile movie data area 43. The DRM validation module 44 controls the movie decoder module 41 to allow or disallow it to decode the movie data from the mobile movie data area 43 on the basis of a decision made using the DRM data, and time/date or serial number inputs as appropriate. When allowed by the DRM validation module 44 to decode movie data from the mobile movie data area 43 and when controlled to do so by user input, the movie decoder module 41 uses the codec 42 to decode the data and provide decoded data to a buffer 45. From the buffer 45, the movie is displayed on a display 46 by a display module 47. The display module provides control data to the movie decoder module 41 so as to enable decoding at a suitable rate.

The mobile telephone 40 is arranged to install a loader program from the mobile movie data area 43, if one is stored there. The loader program then causes the mobile telephone 40 to determine its configuration, and to select a media player, also stored in the mobile movie data area 43, accordingly. This media player then is used to consume the movie content data. If a suitable media player is already installed in the mobile telephone 40, then this is used instead, and no media player then is installed from the mobile movie data area 43.

Although the mobile device is said to be a mobile (cellular) telephone, it may instead be a personal digital assistant (PDA), which may or may not have bidirectional voice communication capabilities. The invention is primarily concerned with providing audio-visual content on a device which is designed primarily for another function. However, the invention is concerned also with dedicated media players.

Where a movie on a DVD is to be provided onto transferable media for use with a general class of target mobile devices, or even where the movie is to be provided for more than a small number of target devices on the same model number, a system such as a system shown in FIG. 5 can be used to advantage. In FIG. 5, first to third servers 30, 31, 32 are shown. The first server 30 is designated as a management node, and includes connections to each of the second and third servers 31, 32, which constitute child nodes. Each of the servers 30 to 32 includes at least first and second DVD drives 33. In this example, DVDs need to be inserted into and extracted from the DVD drives 33 manually, although it is possible to use robots or other automation for this task instead if required.

Each of the servers 30 to 32 extracts and converts films from DVDs in the DVD drives 33 in parallel. Movies can be extracted from DVDs in a single drive sequentially, i.e. one after the other.

Assuming sufficient speed for the DVD drive 33 and sufficient processing speed for the servers 30 to 32, the DVD extraction and conversion process can be completed in respect of one DVD in tens of minutes. Thus, where a serial number of a target device or similar is to be included in the resulting movie to enable the movie to be reproduced only on that target device, the conversion process needs to be effected once for each specific target device. It will be appreciated that the extraction process needs to be performed only once, since the extracted movie is stored in the extracted movie data buffer.

Where a movie is to be used for a number of target devices of the same class, then the extraction and conversion processes need to be performed only once. Once the movie is stored in mobile format in the mobile format movie data area 20, it can be copied to an MMC or other removable media device as many times is required. This can be carried out in a suitable manner, for example using internal or external MMC drives.

The setup for the management system installation specific architecture is in flat files, for example, in a /etc/ subdirectory. The setup for movie production is in database tables using a custom Postgres or Oracle database, although any other suitable database can be used instead, depending on the scale and performance requirements. The management system running on the child node servers 31, 32 communicate with the management system on the first server 30. The management node 30 is responsible for task allocation. One instance of the management system is required for each conversion session.

1. Apparatus for providing audio-visual content for reproduction on a mobile device, the apparatus comprising:
an audio-visual content supply arrangement;
the apparatus being arranged to write into an area of memory data constituting:
audio-visual content;
two or more media players; and
a loader program,
the loader program being arranged such that when loaded into a mobile device it causes configuration parameters of the mobile device to be determined, causes one of the media players to be selected oh the basis of the detected configuration parameters, and controls the mobile device to use the selected media player.

2. Apparatus as claimed in claim 1, in which the loader program is arranged to control the mobile device to detect whether or not it already includes a suitable media player and, if a suitable media player is detected, this is controlled to be used instead of installing a media player from the area of memory onto the mobile device.

3. Apparatus as claimed in claim 1 in which the two or more media players are provided through a single configurable media player software application.

4. Apparatus as claimed in claim 3, in which the loader program is operable to determine what media player is required, and to operate appropriate software modules forming part of the media player software.

5. Apparatus as claimed in claim 3 in which the loader program forms part of the media player software application.

6. Data stored on a portable medium or existing at least transiently in memory, the data constituting:
audio-visual content;
two or more media players; and
a loader program,
the loader program being arranged such that when loaded into a mobile device it causes configuration parameters of the mobile device to be determined, causes one of the media players to be selected on the basis of the detected configuration parameters, and controls the mobile device to use the selected media player.

7. Data as claimed in claim 6, in which the loader program is arranged to control the mobile device to detect whether or not it already includes a suitable media player and, if a suitable media player is detected, this is controlled to be used instead of installing a media player from the data onto the mobile device.

8. Data as claimed in claim 6 in which the two or more media players are provided through a single configurable media player software application.

9. Data as claimed in claim 8, in which the loader program is operable to determine what media player is required, and to operate appropriate software modules forming part of the media player software.

10. Data as claimed in claim 8 in which the loader program forms part of the media player software application.

11. A method of providing audio-visual content for reproduction on a mobile device, the method comprising:
writing into an area of memory data constituting:
audio-visual content;
two or more media players; and
a loader program,
the loader program being arranged to cause a mobile device to determine configuration parameters of the mobile device, to select one of the media players on the basis of the detected configuration parameters, and to control the mobile device to use the selected media player.

12. A method as claimed in claim 11, in which the loaderprogram is operable to control a mobile device to detect whether or not it already includes a suitable media player and, if a suitable media player is detected, controlling this to be used instead of installing a media player from the area of memory onto the mobile device.

13. A method as claimed in claim 11 in which the two or more media players are provided through a single configurable media player software application.

14. A method as claimed in claim 13, in which the loader program is operable to determine what media player is required, and to operate appropriate software modules forming part of the media player software.

15. A method as claimed in claim 13 in which the loader program forms part of the media player software application.

16. A method of operating a mobile device, the method comprising:
storing audio-visual content data and two or more media players in internal and/or external memory;
determining configuration parameters of the mobile device,
selecting one of the media players on the basis of the detected configuration parameters, and
using the selected media player to consume the audio-visual content data.

17. A method as claimed in claim 16, the loader program controlling the mobile device to detect whether or not it already includes a suitable media player and, if a suitable media player is detected, controlling this to be used instead of installing a media player from the area of memory onto the mobile device.

18. A method as claimed in claim 16 in which the two or more media players are provided through a single configurable media player software application.

19. A method as claimed in claim 18, the loader program determining what media player is required, and operating appropriate software modules forming part of the media player software.

20. A method as claimed in claim 18 in which the loader program forms part of the media player software application.
